(19) United States
(12) Patent Application Publication
(10) Pub. No.: US 2021/0170231 A1
(43) Pub. Date: Jun. 10, 2021

(54) DISTRIBUTED RACE TIMING SYSTEM WITH REAL TIME FEEDBACK FOR PARTICIPANTS

(71) Applicant: Salvatore Paxia, New York, NY (US)

(72) Inventor: Salvatore Paxia, New York, NY (US)

(21) Appl. No.: 17/109,653

(22) Filed: Dec. 2, 2020

Related U.S. Application Data
(60) Provisional application No. 62/945,175, filed on Dec. 8, 2019.

(51) Int. Cl. A63B 24/00; A63B 71/06; G06K 19/077; G06K 19/07; G07C 1/24; H04W 4/029; H04W 4/80; H01Q 7/00

(52) U.S. Cl. CPC A63B 24/0021; A63B 71/0686; G06K 19/07762; G06K 19/0723; G07C 1/24; A63B 2071/0688; H04W 4/80; H01Q 7/00; A63B 2024/0025; A63B 2225/54; H04W 4/029

(57) ABSTRACT

A race timing system according to aspects of the invention includes a tracking device (or “TAG”) that is disposed in a vicinity of, and that moves with, a participant in a race taking place on a racecourse. The tracking device, which can be for example an active RFID tag worn, carried, dragged or pushed along (collectively, “carried”) by the participant, transmits a first identification signal unique to that participant and/or to the tracking device itself. An ad hoc (or itinerant) checkpoint is disposed in a vicinity of the racecourse during a portion (but not the entirety) of the race. The itinerant checkpoint transmits, e.g., to a central event timing server (i) the location of the itinerant checkpoint at or around the time of its receipt of the first identification signal from the tracking device, and (ii) a second identification signal unique to the participant and/or tracking device—which second identification signal may be the same as the first identification signal.

This claims the benefit of priority of U.S. Patent Application Ser. No. 62/945,175, filed Dec. 8, 2019, entitled DISTRIBUTED RACE TIMING SYSTEM WITH REAL TIME FEEDBACK FOR PARTICIPANTS, the teachings of which are incorporated by reference herein.

### BACKGROUND OF THE INVENTION

In many sport events like running races, triathlons, motor sport events, model car racing and other similar events, the timing of the participants is very important. Competitors want to know right away their results and how well they did compared to similar races in which they have participated in the past, what their classification is within their age group, if they beat a friend running in the same race, and other interesting statistics.

Spectators, especially for events on long courses, like marathons and ironman triathlons, also want to know right away, possibly even during a race, how well their friend or relative is doing, and when they should expect them to reach their position or the finish line.

To compile the official classifications, usually the organizers keep track of the passage of participants through the start and finish lines and through multiple checkpoints. They then compute the official “gun time” and “net time” for each participant and publish the classifications. A central system receiving in real time the timing data from checkpoints can also offer this data to spectators, and compute the approximate position of the participants along the course.

For an event with few participants, like a high school track meet, it is possible for the organizers to manually keep track of the passage of participants through the official checkpoints and note the time. For larger events or events that require greater precision in the official results, automated systems are essential.

In prior art systems, the cost to set up and operate a timing checkpoint is usually high; hence, race participants are localized using a small number of checkpoints. Athlete localization away from checkpoints is usually inaccurate.

Systems that automatically record the event times and compute results and statistics have been available for decades and are mostly based on RFID technology. RFID systems used in sport events can use both passive and active RFID tags. An RFID tag is given to each participant of the event, and RFID readers at checkpoints will automatically record the time of passage of each participant.

Passive RFID tags rely entirely on the readers as their power source. These tags can be read up to 20 feet (six meters) away, they have much lower production costs and they are usually manufactured to be disposable.

Active RFID tags use batteries to power up their internal circuits and broadcast radio waves to a reader. These tags contain more hardware than passive RFID tags and they are usually more expensive. Once activated by a reader, these tags broadcast high frequencies from 400 Mhz to 2.4 Ghz that can be read up to 300 feet (100 meters) away.

Passive RFID readers must transmit their activation signal with a lot more power to transfer enough energy to wake up a tag in range and allow it to send a feedback signal, so they are usually more expensive than active RFID readers. Both systems, though, require large investments especially when organizers want to place frequent checkpoints along the course to offer spectators a more precise localization of the participants.

The official feedback systems for participants, even for important events, usually consisting of large display clocks showing the official event time at multiple locations along the course, are often unsatisfactory. Participants can't see their “gun” or “net time” and compare it with the time of other participants. Most athletes though, usually carry a sports watch, a bicycle head unit or another similar device with a display, GPS and radios to connect to other sensors, like pedometers, power meters and heart rate monitors.

Objects of the invention are to provide improved apparatus, systems and methods for timing sporting and other events.

Related objects of the invention are to provide such improved apparatus, systems and methods as facilitate timing and tracking participants at low cost.

Related objects of the invention are to provide such improved apparatus, systems and methods as can be used for races.

Further related aspects of the invention are to provide such improved apparatus, systems and methods as provide improved real time feedback for participants.

### SUMMARY OF THE INVENTION

The foregoing are among the objects attained by the invention, which provides in some aspects apparatus, systems and methods for distributed sports-event timing that take advantage of ad hoc (or “itinerant”) checkpoints to time and/or track participants in a race.

For example, a race timing system according to some aspects of the invention includes a tracking device (or “TAG”) that is disposed in a vicinity of, and that moves with, a participant in a race taking place on a racecourse. The tracking device, which can be for example an active RFID tag worn, carried, dragged or pushed along (collectively, “carried”) by the participant, broadcasts or otherwise transmits a first identification signal unique to that participant and/or to the tracking device itself. An ad hoc (or itinerant) checkpoint is disposed in a vicinity of the racecourse and may move thereabout. This can be, for example, a mobile phone or other mobile communications device (or, simply, “mobile device”) carried by a spectator, race official or other thing.

The itinerant checkpoint includes a receiver that receives the first identification signal from the tracking device, a location sensor that determines a location of the itinerant checkpoint, and a transmitter that transmits (i) the location of the itinerant checkpoint at or around the time of its receipt of the first identification signal from the tracking device, and (ii) a second identification signal unique to the participant and/or tracking device—which second identification signal may be the same as the first identification signal. That information can be transmitted in real-time to a central server (i.e., substantially concurrently with receipt of the first identification signal by the itinerant checkpoint), or at a later time (e.g., at the conclusion of the race).

According to related aspects of the invention, the itinerant checkpoint is disposed in the vicinity of the racecourse during only a portion (but not the entirety) of the race.

According to related aspects of the invention, one or more itinerant checkpoints are added or removed from the timing system during the race, e.g., as spectators whose mobile phones are configured as itinerant checkpoints go near or stray away from the racecourse and/or start or stop mobile apps on their phones that so configure them.

Related aspects of the invention provide a race timing system, e.g., as described above, where the tracking device periodically transmits the first identification signal, e.g., throughout the duration of the race. In another related aspect of the invention, the tracking device can transmit that identification signal with timing information based, for example, on a time that the tracking device crossed a prior checkpoint in the race. In a further related aspect of the invention, the tracking device can broadcast the first identification and/or timing information via a Bluetooth beacon.

In other aspects, the invention provides a race timing system, e.g., as described above, where the transmitter of the itinerant checkpoint transmits its location and the second identification signal to a central event timing server substantially concurrently with receipt of the first identification signal. In other embodiments, the itinerant checkpoint can alternatively or in addition delay transmission of this information to the central event timing server, e.g., until after completion of the race.

According to still other aspects of the invention, the tracking device of a race timing system, e.g., as described above, provides timing feedback for race participants, e.g., via “smart” watches or other wearable or portable digital data devices that have displays, and without the necessity of modifying those devices or requiring that they be connected to the central event timing server. In this regard, it will be appreciated that existing systems providing race feedback on participants' watches and head-units require changes to them and/or a connection to a central event timing server. Systems according to the aforesaid aspects of the present invention work with off-the-shelf (or otherwise unmodified) smart watches or other such devices which support connections to ANT sensors and the possibility of displaying additional fields related to these sensors (for example Garmin sport watches and head units using the Connect IQ system).

According to some related aspects of the invention, a smart watch or other such device is paired to the tracking device (e.g., via ANT) and configured to display an available feedback field, typically, before the start of the race. During the race, the tracking device obtains “official” timing information (e.g., from a checkpoint) and transmits it via ANT to the paired smart watch or other device, which displays it to the participant.

Other aspects of the invention provide race timing systems, e.g., as described above, that additionally include one or more fixed checkpoints, each disposed in a fixed location in a vicinity of the racecourse during the race. Such a fixed checkpoint, which can also serve as a central timing server, can include a loop or other antenna that broadcasts a checkpoint identification in a vicinity of the racecourse nearby that antenna. A tracking device, e.g., as described above, can include radio frequency identification (RFID) logic that responds to reception of that ID by transmitting a third identification signal unique to the participant and/or the tracking device, where the third identification signal may include like identifying information as the first and/or second identification signals. The fixed checkpoint can transmit to the central event timing server an identification of the participant, along with an indication of the time of receipt of the third identification signal.

Still other aspects of the invention provide a race timing system, e.g., as described above, in which the mobile devices carried by spectators or others are configured as itinerant checkpoints and, thereby, facilitate determining more precise locations of race participants who are between or otherwise away from regular or “fixed” checkpoints. Such configuration can be via an application that runs on those mobile devices and that receives real-time information about the race from any tracking devices in the vicinity.

When tracking devices carried by multiple participants, pass within range of a spectator who whose mobile phone is so configured, the tracking device beacons (and their respective tracking device IDs) are received by the mobile phone/itinerant checkpoint which determines the approximate distance of each such tracking device from the spectator. The itinerant checkpoint can determine when a tracking device is closest to the mobile phone and then forward the detection time and distance, the tracking device ID and the GPS position of the central timing event server. The participant-athletes can then be more precisely localized by placement of additional itinerant checkpoints between or away from fixed (or “regular”) checkpoints, which in the illustrated embodiment remain fixed in their respective locations along the course during the entirety of the race.

Further aspects of the invention provide systems as described above in which one or more of the checkpoints provide feedback data to the tracking devices including timing and/or ranking information for display to the respective participants.

Further aspects of the invention provide tracking devices and/or virtual checkpoints constructed and/or operating as described above.

Still other aspects of the invention provide methods of operating race timing systems, tracking devices and/or virtual checkpoints paralleling the respective operations above. The foregoing and other aspects of the invention are evident in the text that follows and in the drawings.

### BRIEF DESCRIPTION OF THE ILLUSTRATED EMBODIMENT

A more complete understanding of the invention may be attained by reference to the drawings, in which:

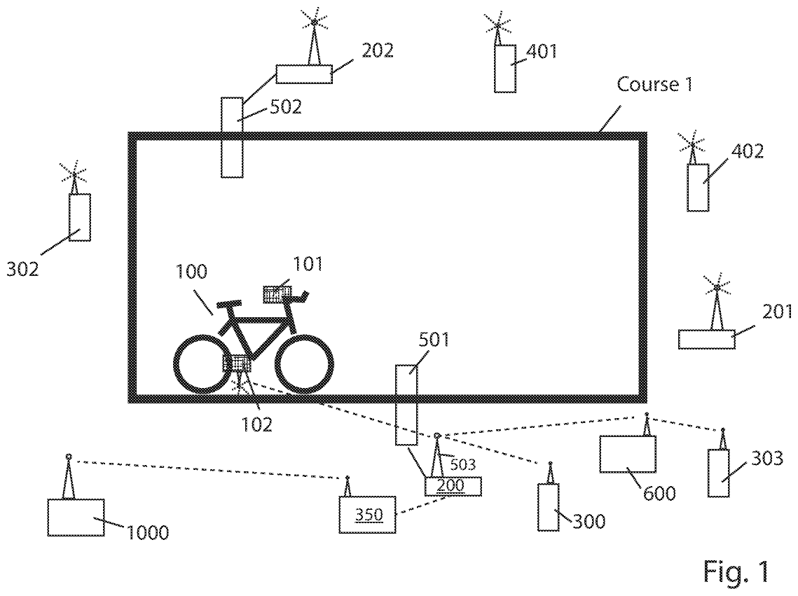

FIG. 1 depicts a race timing system according to one practice of the invention; and

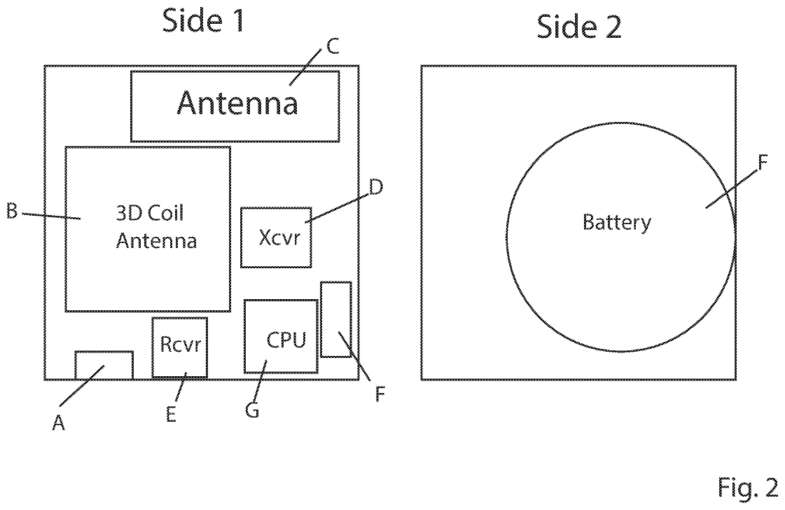

FIG. 2 depicts first and second sides of a logic board of an active tag-based tracking device according to the invention for use in a system according to the invention.

### DETAILED DESCRIPTION OF THE ILLUSTRATED EMBODIMENT

FIG. 1 shows how a system according to one practice of the invention is set up at a race or other event in which participants, e.g., athletes, are to be timed and/or tracked on a course, labeled “Course 1” in the drawing and hereinafter, sometimes, “racecourse” without loss of generality. Here, only a single participant 100 is shown, though, in practice, the system supports timing/tracking many participants in a single race.

The participant 100 (running or on a bike, boat, car, etc.) wears, carries, drags or pushes along (collectively, “carries”) along course 1 a tracking device 102, hereinafter, alternatively referred to as a “tag,” “TAG,” “Active Tag,” or the like, for official timing and an optional wrist or other display device (referred to, below, as a “head unit” device 101). As a consequence, the tracking device 102 remains disposed in a vicinity of, and that moves with, the participant 100 during the course of an event (hereinafter, sometimes referred to as a “race” without any loss of generality) taking place on course 1. The Active TAG 102 is an RFID tag that is activated when approaching a checkpoint and can exchange information with it. The head unit device 101 has a display and one or more wireless connections. One of these connections can be used to interface with the active tag.

The position of the participant 100 along course 1 is determined as he/she passes checkpoints that may be coupled to one another and/or to a central event timing server 1000 as more fully discussed below and illustrated in the drawing via wired connections, wireless connections and/or a combination of both, may be carried via phone lines, cell phone networks, public and private networks, or otherwise, all as is within the ken of those skilled in the art in view of the teachings hereof.

There can be many types of checkpoints along the course:
One or more checkpoints can have an optional loop antenna to transmit an activation signal (checkpoint 200 and antenna 501). In some cases the checkpoint will not transmit an activation signal (checkpoint 201)
One or more checkpoints can have a wireless receiver 503 to receive a message from a tag in response of an activation signal from the same checkpoint 200 or from a periodic signal transmitted by the tag (checkpoint 201)
One or more checkpoints can have an optional wireless connection (also shown by symbol 503 for convenience) to broadcast messages to all the tags 102 and feedback devices 600 within range.
One or more checkpoints can be connected to a computer 350 with an optional WAN uplink. Or they can be connected to a cell phone 300 which provides a WAN uplink. Or they can just store locally the information received from the tags (checkpoint 202)
These and other variations of checkpoints that may be used with the illustrated system will be evident to those skilled in the art in view of the teachings hereof.

Design, fabrication and operation of checkpoints, as well as their constituent components, as described above and elsewhere herein is within the ken of those skilled in the art in view of the teachings hereof.

A central event timing server (or “event server”) 1000 communicates with the connected checkpoints 200, the organizer phones 300 302 303 and computers 350 and with the spectators' devices 401 402 before, during and after the event. At the end of an event (or “race,” without loss of generality), the locally stored data for checkpoints 202 not connected during the event can be uploaded to the event server, as is within the ken of those skilled in the art in view of the teachings hereof.

There are multiple spectators' devices 401, 402 (usually mobile phones) which can receive periodic messages from the Active Tags along the course and determine the approximate locations of the tags. They can upload the received information and/or a GPS position to the event server 1000. Spectators' devices can be added or removed dynamically during the race. In addition, spectators can move freely along the course with those devices.

Feedback to participants and spectators is offered via the head units 101 (e.g., “smart” watches or other wearable or portable digital data devices that have displays and that are carried by the participants) and event displays 600 (e.g., digital billboards and the like). The event displays can receive information from nearby checkpoints 200 or through a wireless or other connection to the event server.

The TAG Technology

Referring to FIG. 2, a tracking device according to and for use with systems and methods of the invention is constructed and operated like a conventional RFID Active Tag of the type known in the art, albeit, as adapted in accord with the teachings hereof. The RFID reader for a tracking device, e.g., per FIG. 2, can be a Low Frequency (125 KHz) transmitter coupled with an antenna which generates a magnetic field to wake up the active tag. The tracking device, e.g., per FIG. 2, will then respond on a High Frequency (2.4 Ghz) band. Different antenna shapes are used depending on the area that one wants to cover. For races, the most widely used is a loop antenna 501, 502, which is basically a rectangular cable loop that is, by way of non-limiting example, 50 cm wide and 2-25 m long placed along the course. When the participant's 100 tag 102 is within or close to the loop, its receiving antenna will be inductively coupled and the transmitter current will be transferred to the receiver antenna.

The advantage of this design is a very low power requirement which is crucial for the duration of a coin battery. Turning on the HF receiver is 100 times more costly than turning on the HF transmitter. The power requirements for a LF analog front end in standby are very low. This design allows a battery to last for years and tens of thousands of wake up/transmit cycles. Those skilled in the art will appreciate that other designs, including those utilizing passive RFID, may be utilized without deviation from the teachings hereof.

FIG. 2 is a schematic showing two sides of an active tag 102 according to and for use in the invention. It has a battery (F), a 3D coil antenna (B) tuned to 125 KHz (basically 3 coils placed along the 3 axes), a 3-channel high sensitivity LF receiver with very low standby power usage (E), a CPU (G) and finally a high frequency transceiver (D). (C) Is the integrated PCB antenna for the HF transceiver. CPU and HF transceiver can be combined in a single chip. A preferred active tag according to the invention has 2 or 3 coil antennas, an LF receiver and a combined CPU/HF transceiver which supports several 2.4 Ghz ISM bands protocols.

It is of note that some LF receiver chips are designed to detect an ASK modulated signal. The message transmitted by the RFID receiver to activate the TAG usually comprises a Carrier signal, a code (usually 16 or 32 bits) and finally a message. Since the LF receiver has a very high sensitivity, the code is used to filter out the background noise which can be misidentified as a carrier signal. Once the code is verified the chip will then parse the message, wake up the CPU and send to the processor the received message. The processor will then send the TAG ID and other information (message received from reader, temperature, battery level, etc.) to the receiver. That TAG ID, which is occasionally referred to herein as the “third identification” may be the same as the first and second identifications discussed below. The RFID receiver can thus encode its ID and other info, like date, time, etc. in the message part of the LF wake up signal. A tag 102 can also carry a motion sensor, which would independently wake up the CPU when it is moved.

Design, fabrication and operation of a tag 102 as described above is within the ken of those skilled in the art in view of the teachings hereof.

System Operation

Before the Event:

Participant 100 information is loaded onto the event server 1000 through mobile devices, websites or similar computer programs, all as is within the ken of those skilled in the art in view of the teachings hereof.

The GPS track of the course, the definition of the laps if a section of the course must be repeated multiple times to complete the event, are optionally loaded onto the event server 1000 before the start of the event. They can be used to improve the accuracy of the localization of checkpoints and spectators. In addition, if multiple events happen simultaneously along the course, like a 10K and a marathon, the details of each race and the assignment of participants to each event can also be loaded onto the event server. Moreover if the participants are divided into multiple waves based on their age, performance or other factors, the information can be loaded onto the event server as well.

At this point a timing tag is assigned to each participant and is associated with him/her on the event server. Each Official Checkpoint 200, 202 (that Is, a stationary checkpoint having an associated loop antenna 501, 502, for detecting passage of sensing devices 102) and its distance from the start (5K, 10K, transition area, etc.) can also be loaded onto the server if necessary.

Each participant 100 can optionally connect to the event server 1000 and upload a limited number of participants or groups for which she wants to receive feedback during the event (“the individual feedback definition”).

The checkpoint data and participant information (including various categorizations M/F/Age/Team/Country, other participant references above) is transmitted from the event server to the checkpoints. This can include both stationed (a/k/a “official”) checkpoints, as well as itinerant checkpoints. This can be effected via a computer or mobile device with means to connect to the event server and at the checkpoint devices simultaneously. Alternatively, the checkpoint can have a wireless WAN uplink to directly connect to the event server.

Those checkpoint devices not yet placed along the course or similar hardware can also be used at this stage to wake the tags from a deep sleep mode, program onto the tags the latest firmware and transmit to them course details, checkpoint data, participant information and the individual feedback definition from the event server.

Instead of using a loop antenna, at this stage, the checkpoint devices can use a less efficient antenna with shorter range for sending messages to an individual active TAG or a more efficient antenna which can broadcast messages to all the tags in a room.

The tag is programmed to enter a state where it will periodically transmit a message (for example a Bluetooth beacon) and allow connections from sport watches. Alternatively, a motion sensor can move the tag to this state. The tag associated with each participant is then given to her. The participants can now pair their sport watches/head units to the assigned Active Tag.

The event server, checkpoints and tags can all share a single “official clock” or not. This is not a prerequisite for the correct functioning of the system. In some cases it can be advantageous to synchronize all the local clocks. This can be done before the event, during the event or after the event. Assuming all the devices have similar clock accuracy, this is equivalent.

In some events, a list of athletes actually starting a race must be prepared. This is important to make sure that all the athletes are accounted for in a potentially dangerous section (for example the swim portion of a triathlon event).

The start line checkpoint or a special checkpoint can be set up to track the athletes entering the start area. This can be accomplish with a regular “loop antenna” or an antenna which broadcasts its signal on a wider area.

The race marshals can then concentrate on finding the athletes in the “start list” that have not entered the start area yet. They can be then struck from the event “start list”.

Start of the Event:

At the start line checkpoint the race is started. The “start” event is communicated to the event server (using an organizer's connected device) and optionally to the checkpoints and active Tags.

Multiple waves or multiple races can be started at different times or simultaneously.

The participants will then move along the course.

Meanwhile the official checkpoints can periodically send a LF activation signal to their loop antenna (let's say every 100 ms or more frequently). This signal can include checkpoint ID and timing information.

Checkpoint Crossing:

When participants' tags pass through a checkpoint loop antenna, the LF signal generated by the checkpoint transmitter will be detected by the LF receiver. If the signal contains the correct information and it is not a result of background noise, the LF receiver will wake up the processor and send to it the information received from the checkpoint.

The tag can receive multiple activation messages while it crosses the checkpoint including a checkpoint ID and optionally timing information. The messages are parsed by the processor.

The tag processor determines (based on received signal strength) which activation message has been received while closer to the midsection of the loop antenna and sends to the checkpoint via a wireless connection its TAG ID and optionally timing information (for example the timing info received within the activation signal itself or the time passed since the tag processor has determined to be at the midsection of the loop antenna).

The timing info is either generated internally by the tag or played back to the checkpoint. This timing info can also contain the time passed since the TAG passed the first checkpoint (“official time” as detected by the TAG itself).

Note that multiple messages can be sent from the TAG to the checkpoint to take care of possible collisions between tags' messages. If the timing info is generated internally by the tag, it will continue to change as time passes.

The checkpoint receives the TAG ID and timing info sent by the TAG, which it can transmit to the central server 1000 in real time (i.e., concurrently with receipt of the TAG ID and timing info from the TAG and/or subsequently, e.g., at the end of the race). The moment of time in which the message is received is marked and stored in local memory. If the tag doesn't include timing information the crossing time recorded by the checkpoint will be approximate, and depend only by the time in which the tag has been activated and how many messages sent by the tag are lost because of possible collisions.

The tag at this point has all the information to compute the individual participant's unofficial statistics, since it has determined the checkpoint passing time at each checkpoint. It optionally has a list of checkpoints and official distances of checkpoints from the start, so it can compute individual elapsed time or “net time”. If the clocks have been synchronized at the start OR if one or more checkpoints have broadcasted the official time, the tag can also compute the participant's “gun time” as well.

Feedback System:

Moreover the TAG at this point is still within checkpoint range, and enters a state in which it expects a feedback message broadcast by the checkpoint with timing information of the respective participant 100. Note that no two-way communication is established between tags and checkpoints. To save power, the tag can stay in this state for a limited time (for example a few seconds).

Meanwhile, the checkpoint has received from the passing TAGs at a minimum the TAG id, and possibly more accurate timing information. Since it has been loaded with all the participant information, at this point it can compute the “gun time” classifications for all the tags which have passed.

If a checkpoint is connected to a central event server and has received previous checkpoint crossings, or if the TAGs have also sent their “net times”, the checkpoint can also compute the “net time” classifications.

After receiving a TAG ID and updating the classifications, the checkpoints will broadcast the feedback data (let's say for all the TAG IDs passed in the last X seconds) on a channel different from the channel in which the tag IDs are received containing updated timing information for the respective race participants. This can include not only their respective gun times and rankings, but also those of the competitors for whom they have also registered to receive that information. The determination of those timings/rankings and the mechanism of their broadcast by the checkpoints is within the ken of those skilled in the art in view of the teachings hereof.

In particular, the TAG of the first “gun time” participant in one or more classifications will only receive the information of being first at this checkpoint. The “gun time” classification for the participants from 2nd position on can be computed by the checkpoint because the participants higher in classification have already passed the checkpoint. Note that “net time” classifications at checkpoints can be useless, because in one extreme case, a participant can start the race after all the other participants have finished and still win the final “net time” race for one or more categories. Note that the gun time classification data is local to each checkpoint. In addition, connected checkpoints can exchange passing information with the event server.

Since the active Tags are expecting these broadcast messages with feedback data they will read them. As soon as their TAG ID is present in a broadcast message, the TAGs will extract the classifications from the message. Again note that messages can be acknowledged or not, but no connection needs to be established with the checkpoints. Finally the tag will stop listening for broadcast messages from the checkpoint just crossed.

Once the tags have determined a checkpoint passing event and optionally extracted from the checkpoint broadcast messages the classifications, they can perform local calculations and then in turn send any relevant data to the sports watch/head unit device using a wireless protocol like ANT or Bluetooth low energy.

Since the watch has been paired in advance, it will take very little power to send these messages to the wrist devices. These messages can be sent periodically. The tag will be the master while the sports watch/head unit will be the slave device.

The feedback displays placed along the course can also receive broadcasts from the checkpoints (if they are within range) or connect to the event server to download data available there.

If checkpoints are connected to the event server, the feedback can also be distributed to spectators through event websites or mobile apps.

Mobile Phone/Itinerant Checkpoint Crossing:

Tags periodically broadcast (or transmit) a Bluetooth beacon (iBeacon) that includes an ID (occasionally, referred to herein as the “first identification”) unique to the participant and/or to the tracking device itself. Ad hoc (or itinerant) checkpoints—here, mobile devices executing apps to configure them as checkpoints, as described below—disposed in a vicinity of the racecourse 1 sense those beacons for each participant 100 in the vicinity and transmit a location to the central server 1000 to facilitate participant timing and tracking. More particularly and as evident in the discussion below, each itinerant checkpoint receives the unique ID contained in the iBeacon and transmits that ID (or another such ID, e.g., corresponding to the received ID, and otherwise unique to the participant and/or TAG from which it was received) to the central server, along with the respective checkpoint's location (e.g., as determined via on-board GPS). That transmitted ID is occasionally, referred to herein as the “second identification.” Alternatively or in addition, the checkpoint can transmit the ID with an estimated location of the participant and/or TAG itself. Regardless, such transmission to the central server 1000 can be done in real-time (i.e., substantially concurrently with receipt of the iBeacon from the TAG) or at a later time (e.g., at the conclusion of the race). Since spectators and others carrying mobile phones (or other devices) serving as itinerant checkpoints may come and go during the course of the race, moving about the course 1, as well, it is assumed that at least some such itinerant devices are present only during a portion of (but not the entirety) of the race.

Thus, for example, mobile devices carried by race organizers and/or by spectators and running a mobile app to configure those devices as itinerant checkpoints, opportunistically detect iBeacon messages transmitted by the TAGS and, using the received signal strength of the message, determine when the tag is closest to the mobile device. Implementation and execution of such a mobile app on a mobile device is within the ken of those skilled in the art in view of the teachings hereof. As per convention in the art, such an app can be maintained on computer-readable storage medium (e.g., the non-transitory memory of a server from which the app is downloaded and/or of the mobile device to which it is downloaded for execution) in the form of data representing software executable by a computer (and, more particularly, the central processing unit of the mobile device) including instructions to cause a mobile computing device to function as an itinerant checkpoint as described herein.

At a minimum, each such message contains the TAG ID. The mobile device will then use the GPS information and send it together with the TAG ID to the event server.

In addition, the timing information (i.e. a checkpoint IDs with the official crossing or the time passed since the crossing) can optionally be transmitted with the beacon. Alternatively or in addition, the TAGs can cycle through all the checkpoint crossing times instead of just transmitting the data for the last checkpoint.

In addition, these beacon messages can be received by checkpoint devices, e.g., 201, which don't have a loop antenna/transmitter instead of a mobile phone. These checkpoints, e.g., 201, can be given more weight by the timing system than the spectators' devices.

In some embodiments, the itinerant checkpoints broadcast or otherwise transmit back to the respective TAGs feedback data of the type discussed above in connection with the fixed checkpoints. This can include not only their participant's respective gun times and rankings, but also those of the competitors for whom they have registered to receive that information. The determination of those timings/rankings and the mechanism of their broadcast by the checkpoints is within the ken of those skilled in the art in view of the teachings hereof.

Finally, if a spectator is interested to be notified when a participant is approaching, it can be easily done in mobile app, since the beacons are received from up to 100 meters away.

Checkpoint Connections:

In some cases it can be advantageous to collect checkpoint crossings but not transmit them right away to the event server. In this case the data is stored locally and uploaded to the event server after the end of the event. This can be used to add additional low cost checkpoints along the course and verify that the participants crossed them.

Checkpoints can be connected (through wired or wireless connections) to computers or mobile phones which can be in turn connected to the event server. Checkpoint can store crossing information locally and/or transmit it to locally connected devices or the event server.

The Conclusion of the Event:

After crossing the last checkpoint, the tags can transmit all the checkpoint crossings and optionally wait for an acknowledgment of the reception of these messages by the last checkpoint. They can then go back to deep sleep mode either because they have detected that the last checkpoint has been passed, via a timer programmed at the beginning of the event, or because the optional motion sensor is inactive.

Event Server:

The event server 1000 can handle multiple races.

For each race it can store the participant information and the various categorizations and a GPS course map.

If checkpoints are set up to transmit crossings in real time the data is stored and used to compute official classifications right away. If the checkpoints and not connected then the timing data is uploaded after the race.

The event server 1000 also collects itinerant checkpoint crossing times and GPS positions. This data together with the course GPS maps can be used to compute in real time the positions of the participants even when checkpoint data is not available.

It has the official event timing. It supports websites and mobile apps which offer feedback information during or after the race.

Penalties and Additional Information

The event organizers or course marshals can also use the system to exchange additional information with the participants. For example, the marshals can assign a timing penalty to a specific participant and they can be relayed directly (if the marshal is at a checkpoint) or indirectly to the participants. The participant's TAG will then receive the penalty info from a checkpoint together with the timing and classification information.

If a timing penalty is taken during a race, that can be transmitted as well, so the participants will know if they still have outstanding penalties.

### CONCLUSION

Described above are apparatus, systems and methods according to the invention. It will be appreciated that the illustrated embodiment is but an example of the invention and that other embodiments incorporating changes thereto fall within the scope of the invention as summarized above and otherwise evident herein.

In view of the foregoing, what I claim is:

1. A race timing system, comprising
A. a tracking device that is disposed in a vicinity of, and that moves with, a participant in a race taking place on a racecourse, the tracking device transmitting a first identification signal unique to the participant and/or the tracking device,
B. an itinerant checkpoint disposed in a vicinity of the racecourse, the itinerant checkpoint comprising
i) a receiver that receives the first identification signal from the tracking device,
ii) a location sensor that determines a location of the itinerant checkpoint,
iii) a transmitter that transmits:
(a) a second identification signal unique to the participant and/or tracking device, where the first and second identification signals may include like identifying information,
(b) a location of the itinerant checkpoint substantially at a time of its receipt of the first identification signal.

2. The race timing system of claim 1, wherein the itinerant checkpoint is disposed in a vicinity of the racecourse during only a portion of the race, where that portion is less than an entirety of the race.

3. The race timing system of claim 1, wherein the tracking device periodically transmits the first identification signal.

4. The race timing system of claim 1, wherein the tracking device transmits timing information with the first identification signal.

5. The race timing system of claim 4, wherein the timing information transmitted by the tracking device is based on a time that the tracking device crossed a prior checkpoint.

6. The race timing system of claim 1, wherein the transmission by the tracking device is a broadcast.

7. The race timing system of claim 6, wherein the tracking device transmits the first identification via a Bluetooth beacon.

8. The race timing system of claim 1, wherein the transmitter of the itinerant checkpoint transmits its location and the second identification signal to a central event timing server.

9. The race timing system of claim 8, wherein the transmitter of the itinerant checkpoint transmits its location and the second identification signal to the central event timing server substantially concurrently with receipt of the first identification signal by the itinerant central event timing server from the tracking device.

10. The race timing system of claim 1, wherein the itinerant checkpoint comprises a mobile communications device.

11. The race timing system of claim 1, comprising one or more fixed checkpoints, each of which is disposed in a fixed location in a vicinity of the racecourse during the race.

12. The race timing system of claim 11, wherein at least one fixed checkpoint includes an antenna that broadcasts a checkpoint identification in a vicinity of the racecourse nearby that antenna.

13. The race timing system of claim 12, wherein the antenna is a loop antenna.

14. The race timing system of claim 12, wherein at least one tracking device includes radio frequency identification (RFID) logic that responds to reception of the broadcast by the fixed checkpoint by transmitting a third identification signal unique to the participant and/or tracking device, where the third identification signal may include like identifying information as the first and/or second identification signals.

15. The race timing system of claim 14, wherein the fixed checkpoint transmits an identification of the participant to the central event timing server along with an indication of the time of receipt of the third identification signal.

16. The race timing system of claim 14, wherein at least one fixed checkpoint transmits to the tracking device for display thereby feedback data that includes information pertaining to any of race timings and rankings.

17. The race timing system of claim 16, comprising a wearable digital data device that is in communications coupling with the tracking device and via which the tracking device displays to the participant race timing feedback.

18. The race timing system of claim 17, wherein the wearable digital data device is a smart watch.

19. A method of race timing, comprising
A. with a tracking device that is disposed in a vicinity of, and that moves with, a participant in a race taking place on a racecourse, transmitting a first identification signal unique to the participant and/or the tracking device,
B. with an itinerant checkpoint that disposed in a vicinity of the racecourse, performing the steps of
i) receiving the first identification signal from the tracking device,
ii) determining a location a location of the itinerant checkpoint,
iii) transmitting
(a) a second identification signal unique to the participant and/or tracking device, where the first and second identification signals may include like identifying information,
(b) a location of the itinerant checkpoint substantially at a time of its receipt of the first identification signal.

20. The method of claim 19, wherein the itinerant checkpoint is disposed in a vicinity of the racecourse during only a portion of the race, where that portion is less than an entirety of the race.

21. The method of claim 20, wherein the itinerant checkpoint moves with respect to the racecourse when disposed in a vicinity thereof.

22. An itinerant checkpoint for a race timing system, the itinerant checkpoint comprising
A. a receiver that receives a first identification signal from a tracking device that is disposed in a vicinity of, and that moves with, a participant in a race taking place on a racecourse, the tracking device transmitting a first identification signal unique to the participant and/or the tracking device,
B. a location sensor that determines a location of the itinerant checkpoint,
C. a transmitter that transmits:
(i) a second identification signal unique to the participant and/or tracking device, where the first and second identification signals may include like identifying information,
(ii) a location of the itinerant checkpoint substantially at a time of its receipt of the first identification signal.
D. wherein the itinerant checkpoint is disposed in a vicinity of the racecourse.

23. The itinerant checkpoint of claim 22, wherein the itinerant checkpoint is disposed in a vicinity of the racecourse during only a portion of the race, where that portion is less than an entirety of the race.

24. The itinerant checkpoint of claim 23, wherein the itinerant checkpoint moves with respect to the racecourse when disposed in a vicinity thereof.

25. The itinerant checkpoint of claim 22, comprising a mobile communications device.

26. A computer readable storage medium having data stored therein representing software executable by a computer, the software including instructions to cause a mobile computing device that is disposed in a vicinity of the racecourse to
A. receive a first identification signal from a tracking device that is disposed in a vicinity of, and that moves with, a participant in a race taking place on a racecourse, the tracking device transmitting a first identification signal unique to the participant and/or the tracking device,
B. determine a location of the itinerant checkpoint,
C. transmit (i) a second identification signal unique to the participant and/or tracking device, where the first and second identification signals may include like identifying information, (ii) a location of the itinerant checkpoint substantially at a time of its receipt of the first identification signal.

27. The storage medium of claim 26, wherein the itinerant checkpoint is disposed in a vicinity of the racecourse during only a portion of the race, where that portion is less than an entirety of the race.

28. The storage medium of claim 27, wherein the itinerant checkpoint moves with respect to the racecourse when disposed in a vicinity thereof.
